(19) United States
(12) Patent Application Publication
(10) Pub. No.: US 2015/0186768 A1
(43) Pub. Date: Jul. 2, 2015

(54) TRANSPARENT RFID ANTENNA

(71) Applicant: Eric MacKenzie Peters, Hayward, CA (US)

(72) Inventor: Eric MacKenzie Peters, Hayward, CA (US)

(73) Assignee: ASSA ABLOY AB, Stockholm (SE)

(21) Appl. No.: 14/394,812

(22) PCT Filed: Apr. 18, 2012
(86) PCT No.: PCT/US12/34065

§ 371 Date: Feb. 2, 2015

(51) Int. Cl. G06K 19/077

(52) U.S. Cl. CPC G06K 19/07783; G06K 19/07743

(57) ABSTRACT

A transponder having a transparent conductive material deposited thereon is disclosed. Specifically, the transparent conductive material forms an antenna or antenna portion of the transponder. The transparent conductive material includes a plurality of nanometer-sized materials that are integrated in a polymer solution. The nanometer sized materials are smaller than the wavelengths of visible light and therefore do not block or interfere with the visible light rays transmitted. Even at relatively high loading levels for the nanometer sized materials in the polymer solution, the polymer solution remains transparent in the visible light spectrum. The resulting conductive coating is also substantially transparent in the visible spectrum.

### FIELD OF THE DISCLOSURE

The present disclosure is generally directed toward antennas and specifically directed toward transparent antennas.

### BACKGROUND

Radio Frequency Identification (RFID) systems typically include at least one reader and a plurality of transponders, which are commonly termed credentials, cards, tags, key fobs, or the like. The transponder may be an active or passive Radio Frequency (RF) communication device which is directly attached to or embedded in an article to be identified or otherwise characterized by the reader. Alternatively, the transponder may be embedded in a portable substrate, such as a card or tag, carried by a person to be identified or otherwise characterized by the reader. An active transponder is powered up by its own internal power supply, such as a battery, which provides the operating power for the transponder circuitry, often in the form of an Integrated Circuit (IC) chip or a collection of RFID chips (often referred to as a module). In contrast, a passive transponder is characterized as being dependent on the reader for its power. The reader “excites” or powers up the passive transponder by transmitting excitation signals of a given frequency into the space surrounding the reader, which are received by the transponder and provide the operating power for the circuitry of the recipient transponder.

Communication between the reader and transponder is enabled by cooperative resonant circuits which are provided in each reader and transponder. The resonant circuit of a reader typically includes an inductor and a capacitor. The capacitor is coupled in series between the inductor and a signal driver. The inductor is usually in the form of an antenna coil, which is capable of magnetically coupling to an inductor in the resonant circuit of a compatible transponder through mutual inductance. Communication is initiated when a transponder is proximally positioned relative to the reader. The reader has a power supply which conveys a current to the reader resonant circuit causing the reader antenna to produce an excitation signal in the form of an electromagnetic field. The excitation signal couples to the antenna of the proximally-positioned transponder through mutual inductance and the excitation signal powers and clocks the transponder circuitry initiating operation of the transponder.

Transponder operation comprises generation of a response signal at a specified frequency and transmission of the resulting transponder response signal back to the reader. In particular, the transponder resonant circuit receives a current in response to the excitation signal, which causes the transponder antenna to produce a response signal in the form of an electromagnetic field. The response signal couples to the reader antenna through mutual inductance in substantially the same manner as described above with respect to coupling of the excitation signal to the transponder antenna.

The RFID chip of the transponder modulates the response signal to encode data stored in the memory of the transponder circuitry into the response signal. When the response signal generated by the transponder antenna couples to the reader antenna, a corresponding voltage is induced in the reader antenna at the specified frequency. The reader processes the induced voltage to read the data encoded in the response signal. The resulting data may be communicated to an output device, such as a display, printer, or storage device, and simultaneously, or alternatively, communicated to a host computer, if a host computer is networked into the RFID system.

The three most common methods of forming antennas for a transponder are (1) coiled coated wires embedded in plastics, (2) evaporated metals on plastics, (3) highly metal particle-filled plastic resins printed on plastics, and (4) metal-filled inks

The coiled fine wires must be coated and then embedded into the plastic of the identification card. The antennas are attached to the RFID chip through fine wire leads. In most identification card applications, the coils need to be flattened.

Evaporative metal leads are not normally applied directly to the structural plastic in the card due to the cost and complicated equipment required. The evaporation of metal to form antennas directly on the plastic requires metal masks or rotary masks, which need to be continually cleaned.

The thickness of the structural plastic limits the size of the roll that can be placed in the vacuum coater, which increases the cost. For these reasons producers normally use thinner films and coat the entire width of the web. Antennas are then made from this material by either die cutting the antenna's shape out of the web and applying to the cards with adhesive or hot stamping the structure onto the plastic using an antenna shaped pressure shoe.

With respect to metal-filled inks, these metallic inks are often applied to plastic sheets by screen-printing or ink jet printing. Screen-printing allows the printer to apply a greater thickness of ink in a single pass than rotogravure or lithographic printing techniques. The conductive metallic ink requires these greater thicknesses to provide the required conductivity of the antenna path. Ink jet printing is also used to form the antennas but is normally more expensive. Ink Jet printing is used in products where the antenna shapes vary for the radio frequency generated or the product is a short run or custom product (i.e., only a few RFID transponders are required).

None of the current methods of forming antennas result in a transparent antenna, which means that the antenna must be concealed on the final product, thereby increasing production costs. The antenna can be directly visible if left uncovered or in transparent material like on some credit cards. Antennas embedded in the middle of a card behind art work are easily visible with an intense light source. The consumer and forgers can easily know that the card contains a RFID antenna and digital information. The concentration of conventional pigments in the exterior plastic films cannot be high enough to completely hide the antenna within the cards.

Another problem with existing antenna-manufacturing techniques is that most of current methods of construction do not create flexible antennas. Rather, the above-mentioned methods of constructing antennas for transponders often result in brittle or fragile antennas or connections between the antenna and the RFID chip. If the transponders are bent too much, the antenna can crack and fail. Specifically, the antenna tends to be more fragile than the overall transponder construction. Polycarbonate (PC) cards which are more robust than polyvinyl chloride (PVC) or polyethylene terephthalate (PET) have a greater problem.

Transparent antennas per se are not new in the art. Most of the recent developments have been made for applications as such as within windows, cell phones, tablets or notebooks.

However, some techniques have been proposed to manufacture transparent antennas for RFID transponders.

One example is described in WO2010/126876, the entire contents of which are hereby incorporated herein by reference. The '876 publication describes the principle of using a transparent conductive paste for printing as a transparent antenna. Unfortunately, the paste proposed in the ‘876 publication is brittle.

WO2011/0059151 proposes a solution to create transparent RFID antenna on plastic material, but using metal oxide material implemented by micro-strip electrodes. This technique is expensive, costly and questionable whether it can be adapted to the constraint of large manufacturing processes. No mention is made about the mechanical features of the resulting antenna.

Finally, US2007/0296592 discloses a transparent RFID antenna disposed on a LCD display panel. The material of the transparent antenna comprises ITO or IZO and the antenna can be formed by printing or photolithography. Here also, the resulting antennas present none of the desired flexibility features that would be particularly desirable for use with RFID transponders.

### SUMMARY

It is, therefore, one aspect of the present disclosure to provide an improved transparent antenna for RFID transponders or as security features for objects. It is also an aspect of the present disclosure to provide methods of constructing RFID transponders with improved antennas.

In particular, a new material is proposed herein for constructing transparent antennas for RFID transponders, credentials, cards, identification documents, tags, chips, etc.

The transparent conductive material may comprise a plurality of nanometer-sized conductive elements (e.g., particles, wires, and/or tubes) that are mixed into a solution. The transparent nature of the conductive material is achieved by using conductive elements that are smaller than the wavelengths of visible light. The nanometer-sized elements may be mixed into a transparent polymer solution which can change the refractive index of the solution, but does not block the transmission of light due to the sub visible wavelength size of the materials, thereby resulting in a transparent conductive solution. From such a solution, coatings can be achieved which can be applied to plastic or ceramic materials. The coating solutions, which may also be referred to as a nanoparticle ink, can be applied to the materials to form transparent conductive antennas for RFID transponders and other similar devices.

The nanoparticle inks, in addition to being transparent in the visible spectrum, have greater flexibility than antennas of the prior art. The nanowires and nanotubes tend to have greater conductivity at lower fill levels and the shapes of the thin filaments make them more flexible. Spherical nanoparticles can also be loaded into the inks at lower levels to provide greater flexibility for the ink. The nanometer materials also provide reinforcement to the base polymer in which they dispersed. The resulting conductive inks can have better mechanical properties than the base polymer coating without the nanometer materials.

Because the material proposed herein is more flexible than current conductive printed materials, new antennas can be achieved that are more robust than previous ones. In other words, antennas can be made with the transparent conductive material described herein to achieve better flexibility and more closely match the properties of the transponder substrate (e.g., polycarbonate (PC), polyvinyl chloride (PVC), polyethylene terephthalate (PET)). Transponder substrates could also be considered that are not normally used today (eg. Thermoplastic elastomers (TPE), Thermoplastic Olephins (TPO), silicons, rubbers, etc.)

These conductive materials can be printed on the surface or interior component of an identity card to form a transparent and flexible antenna, electrode, or trace. The transparent conductive material can be printed using conventional screen-printing techniques or inkjet printing. The small size of the nanometer-sized conductive elements also minimizes the risk of clogging printer nozzles, thereby enabling the use of ink jet printing in addition to screen-printing.

The material proposed herein can also be used to create electrodes, traces, and other circuit elements.

In addition to comprising conductive properties, the materials discussed herein may also be used to form optical memory recording materials. Accordingly, it is another aspect of the present disclosure to utilize nanometer-sized elements that absorb near-infrared light and form optical memory recording materials on identification documents, transponders, or the like. The properties of these materials may also enable the nanoparticle ink to be simultaneously printed on plastic to form both optical memory and antennas/electrodes/traces on the same plastic surface. Thus, a single printing step may be performed on a surface of hard-coated PC, for example, thereby resulting in the creation of optical. Before or after the printing step, the RFID chip may be mounted or otherwise secured to the plastic surface or into a recess in the plastic substrate.

The present invention will be further understood from the drawings and the following detailed description. Although this description sets forth specific details, it is understood that certain embodiments of the invention may be practiced without these specific details. It is also understood that in some instances, well-known circuits, components and techniques have not been shown in detail in order to avoid obscuring the understanding of the invention.

### BRIEF DESCRIPTION OF THE DRAWINGS

The present disclosure is described in conjunction with the appended figures:

FIG. 1 is a component view of a transponder in accordance with at least some embodiments of the present disclosure;

FIG. 2 is an exploded view of the antenna and RFID chip of a transponder in a first configuration in accordance with embodiments of the present disclosure;

FIG. 3 is a first plan view of a transponder in accordance with at least some embodiments of the present disclosure;

FIG. 4 is a second plan view of a transponder in accordance with at least some embodiments of the present disclosure;

FIG. 5 depicts an alternative transponder arrangement in accordance with embodiments of the present disclosure;

FIG. 6 depicts another alternative transponder arrangement in accordance with embodiments of the present disclosure; and

FIG. 7 depicts additional details of a contact module for a transponder in accordance with embodiments of the present disclosure.

### DETAILED DESCRIPTION

The ensuing description provides embodiments only, and is not intended to limit the scope, applicability, or configuration of the claims. Rather, the ensuing description will provide those skilled in the art with an enabling description for implementing the described embodiments. It being understood that various changes may be made in the function and arrangement of elements without departing from the spirit and scope of the appended claims.

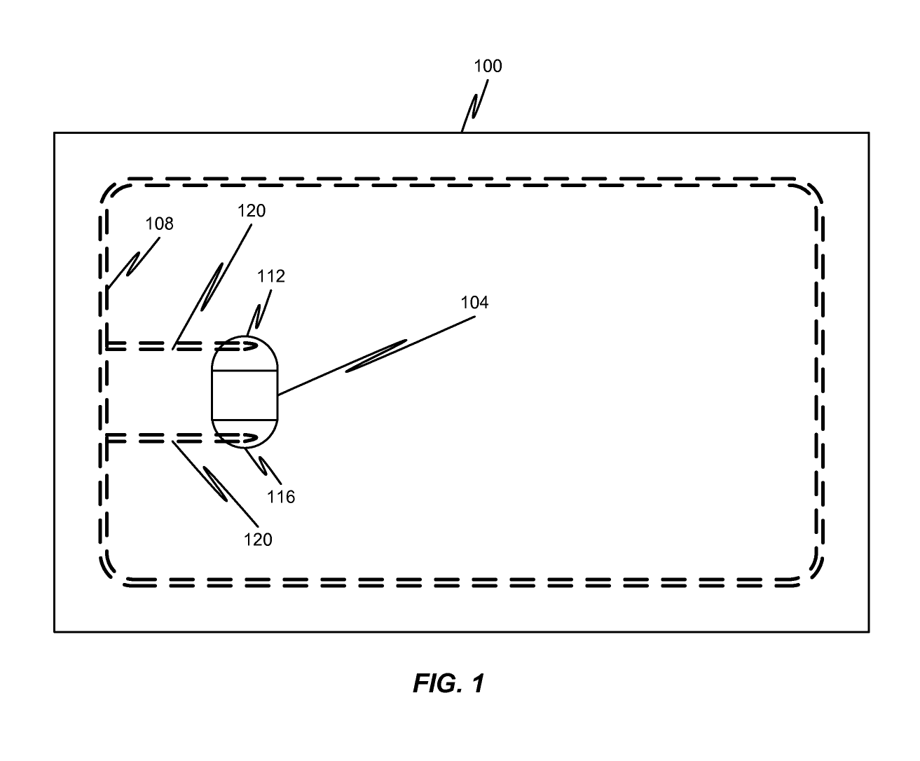

With reference initially to FIG. 1, a first transponder 100 and components thereof will be described in accordance with at least some embodiments of the present disclosure. Although embodiments of the present disclosure will be described in connection with a card-type transponder, those of skill in the art will appreciate that the features disclosed herein may be applied to create a transparent and electrically-conductive component such as an antenna, electrode, and/or electrical trace in any form-factor. Non-limiting examples of such form factors include identification documents, cards, key fobs, tags, stickers, badges, clothing, merchandise, containers, conductive security elements, and the like.

FIG. 1 depicts a first example of a transponder 100 having a transparent antenna 108. The antenna 108 can be constructed of a transparent conductive material having nanometer-sized conductive elements incorporated therein. Specifically, the nanometer-sized conductive elements (e.g., particles, wires, tubes, etc.) may be incorporated into a solution to create nanoparticle ink that is printed onto the substrate of the transponder 100. More specifically, the transponder 100 may be constructed of a plastic material or plastic composite (e.g., PC, PVC, PET, combinations thereof, etc.) and the nanoparticle ink may be printed onto the plastic material in the shape of an antenna 108. Screen-printing and/or inkjet printing techniques may be employed.

Normally, metallic, organic or dielectric nanoparticles are difficult to disperse evenly throughout an organic liquid. Silica nanoparticles formed in aqueous solutions for example are almost impossible to redisperse in an organic solution. Once the nanoparticles are removed from the aqueous solution the electrostatic forces between the particles are so great that even with high shear mixing the particle will remain in clumps of 100 or more. Similarly organic tonner particles used in xerographic printing if milled below a few microns will clump in larger agglomerates.

Over the years synthesis techniques have been developed to create particles in-situ in organic solvents. The formation of silica particles in aqueous solutions and then suspension in organosilanes by solvent exchange for example was patented by Toray Chemical and led to the development of the first generation of optical hard coats. The solvent exchange techniques although useful for optical hardcoat applications were limited in the type of dielectric and inorganic nanoparticles that can be formed. They were also limited in the shape of the particle that could be formed. To keep the particles suspended as they are formed the synthesis chemicals needed to be in a colloid suspension before they are reacted. In a stable colloid system only spherical particles can be formed.

More recently scientists have developed techniques to create linear inorganic nanoparticles in solution and in vapour. These new morphologies are more useful for the conduction of electrical currents through polymer and dielectric materials. When coating linear structures from solution the nanoparticles align with the plane of the substrate increasing the electrical conductivity across the plane of the coating. The new linear structures have greater conductivity at lower loading levels in polymeric resins and have the potential for greater conductivity while retaining transparency.

A material has been recently developed by Cambrios Technology and is disclosed in the following patent applications WO2008/46058, and WO2007/22226, each of which are hereby incorporated herein by reference in their entirety. As disclosed in these documents, this material is primary intended for making transparent conductive electrodes, for applications like flexible photovoltaic panels, organic LED lightings, touch panels and LCD panels. But radiative elements, like RFID antennas are not at all cited as possible application.

The applicant has got the idea to test this new material to apply it on plastic substrate, as plastic cards. Deposition (printing) tests on different card materials (PC, PVC, PET) were positive. Finally, and this is the core of the invention, the applicant has found out that it is possible to create efficient radiative structures on plastic substrates with such a nanoparticle-based ink.

Additionally, the transponder 100 may comprise an RFID chip or collection of RFID chips in the form of a chip module. The example depicted in FIG. 1 is a module 104, which is connected to the antenna 108 via one or more electrodes, leads, or similar types of conductive pads 112, 116 (referred to hereinafter as “conductive pads” for conciseness), and/or one or more traces 120. There are many methods to connect a printed antenna 108 to a chip module 104, some which are described, for example, in U.S. Pat. No. 7,777,317 and European Patent No. EP1796024, both of which are hereby incorporated herein by reference in their entirety. It should be appreciated that the above-mentioned documents are non-limiting examples of the types of methods that may be employed to connect the antenna 108 to the chip module 104. Other known or yet-to-be-developed mechanisms are also considered to be within the scope of the present disclosure.

In some embodiments, the first conductive pad 112 has a first trace 120 printed on top of it. The second conductive pad 116 has a second different trace 120 printed on top of it. The traces 120 carry electrical signals between the chip module 104 and antenna 108. In some embodiments, the chip module 104 may be placed in the substrate of the transponder 100 and thereafter the traces 120 and/or antenna 108 may be printed on the top surface of the substrate in which the chip module 104 has been placed. In some embodiments, the first and second conductive pads 112, 116 comprise exposed electrical contacts on the top surface of the substrate and when the traces 120 are printed over the exposed electrical contacts, a circuit is created or closed between the conductive pads 112, 116 via the antenna 108.

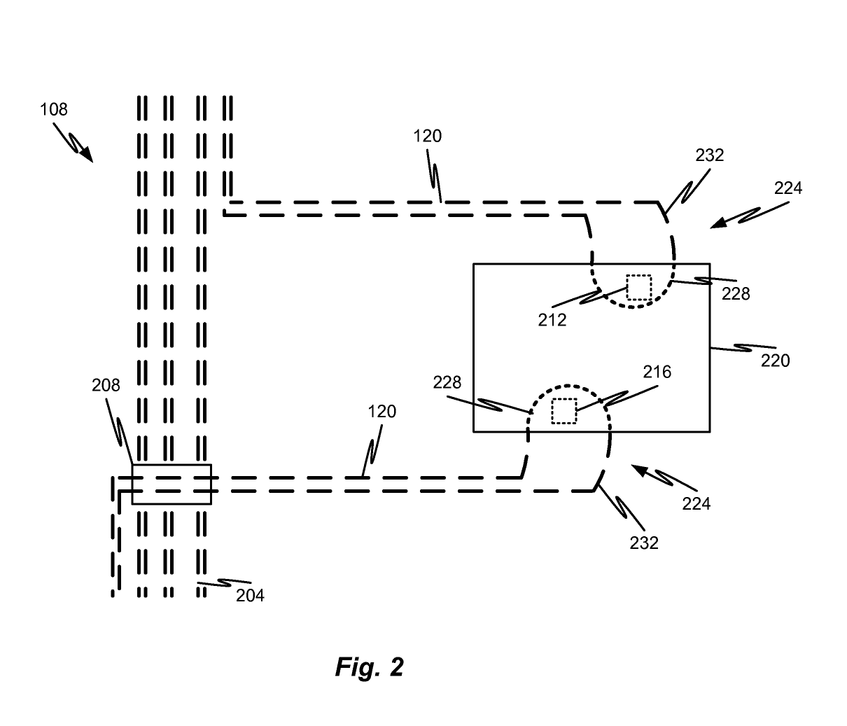

An alternative arrangement is depicted in FIG. 2, where a transponder is shown to include an RFID chip 220 rather than a chip module 104. The RFID chip 220 may have a first and second electrical contact pads 212, 216 on one side of the RFID chip 220 (indicated with dashed lines on the FIG. 2 as there are situated on the bottom surface of the RFID chip 220).

In the embodiment depicted in FIG. 2, the antenna 108 comprises several component parts including one or more inner loops 204, first and second traces 120, and first and second terminal ends 224. One of the traces of the antenna 108 is printed over a bridge material 208. It should be appreciated that the traces 120 may entirely comprise a transparent conductive material that has been printed on the substrate of the transponder 100 as well as on the bridge material 208 that crosses over inner loops 204 of the antenna 108. In other embodiments, the trace 120 may comprise a first portion that is a transparent conductive material that is printed on the substrate of the transponder and a second portion that is either a wire or non-transparent conductive material that is printed on the bridge material 208. Accordingly, the antenna 108, other portions of the trace 120, and any other conductive component (e.g., other trace 120, conductive pads 112, 116, etc.) may be printed in a single printing step and the circuit may be completed by placing the bridge material 208 into its desired location and printing the last connection part of the antenna on it.

The antenna 108 and its component parts including the terminal ends 224 may be printed on a substrate before the RFID chip 220 is placed into the desired position. The relative positions and dimensions of the first and second terminal ends 224 of the antenna 108 are chosen such as once the chip 220 is put in place, each terminal ends 224 comprise a first portion 228 that is located under the RFID chip 220 and a second portion 232 that is not located under the RFID chip 220. In particular, the said dimensions are chosen such that the contacts pads 212 and 216 of the RFID chips 220 can be each put in contact respectively with the conductive paste of one of the portions 228.

Then, the RFID chip 220 may be placed onto the substrate such that the contacts 212, 216 presses down and creates a conductive connection with the terminal ends 224. Placement of the RFID chip 220 may result in the creation or closing of a circuit through the RFID chip 220 via the antenna 108. In some embodiments, the first portion 228 of the terminal ends 224 may be soft or otherwise malleable, thereby enabling the terminal ends 224 to securely connect with the contacts 212, 216. This method I well known in the art under the name “flip-chip” connection method.

As can be appreciated, any combination of known or described methods for connecting a printed antenna 108 to a chip module 104 or RFID chip 220 may be used to achieve a transponder and specifically to connect a chip module 104 or RFID chip 220 to an antenna 108 without departing from the scope of the present disclosure.

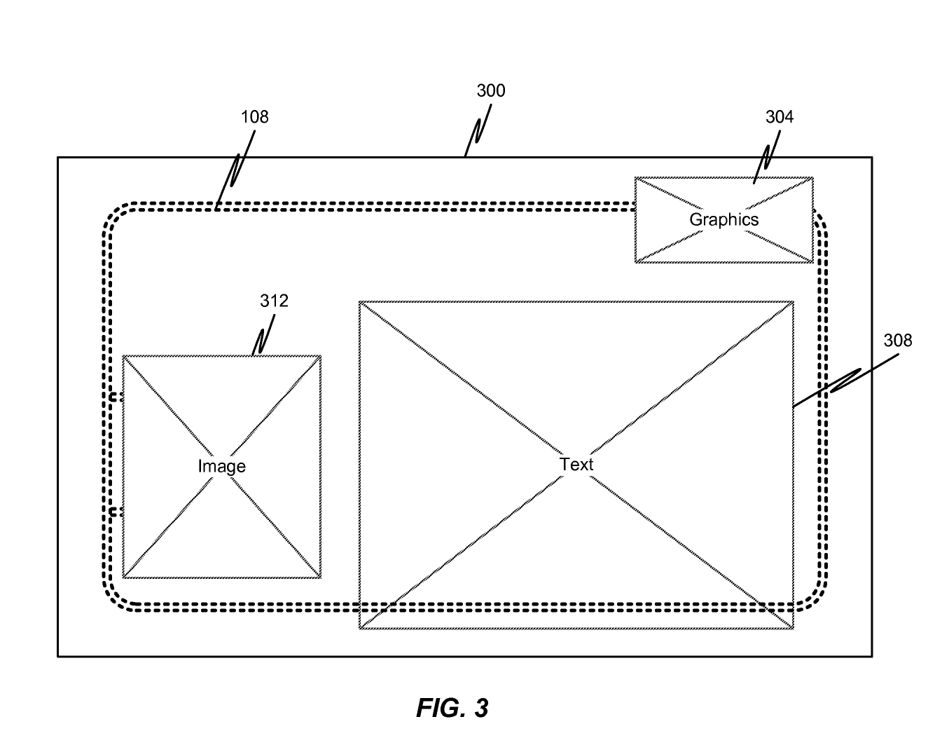

With reference now to FIG. 3, another example transponder 300 will be described in accordance with embodiments of the present disclosure. The transponder 300 shows that the antenna 108 and one or more of its component parts (e.g., traces 120, terminal ends 224, inner loops 204, etc.) may be printed over or under various visible components of the transponder 300 without interfering with the presentation and appearance of such components. In particular, before or after the transparent conductive material of the antenna 108 and other components is printed on the substrate of the transponder 300, one or more of graphics 304, text 308, and images 312 may be printed on the substrate of the transponder 300. Alternatively, or in addition, the transparent conductive material may be printed on the transponder 300 and then a second layer, which may be clear or pigmented, may be placed over the transparent conductive material. One or more of the visible components may be printed, etched, or otherwise established on the second layer or the substrate (e.g., the same layer which has the transparent conductive material printed thereon).

Because of the transparent nature of the transparent conductive material, the antenna 108 made of the transparent conductive material is not visible in the visible light spectrum. As with the text 308 in FIG. 3, one or more visible components of the transponder 300 may have the antenna 108 or other conductive components printed directly thereon and the presentation of the visible component is not altered by the transparent conductive material. FIG. 3 also shows that one or more visible components of the transponder 300 (e.g., graphics 304) may be printed over the transparent antenna 108, but the transparent nature of the material lends itself to having visible components printed thereon. In some embodiments, it may not be necessary or desirable to include visible components in the same region where the chip module or RFID chip is located, but such an embodiment is still considered to be within the scope of the present disclosure.

It should be noted that the transponder 300 may be similar or identical to any previously-described transponders and any features discussed in connection with one transponder (e.g., the transponder 100) may be applied to the other transponder (e.g., the transponder 300).

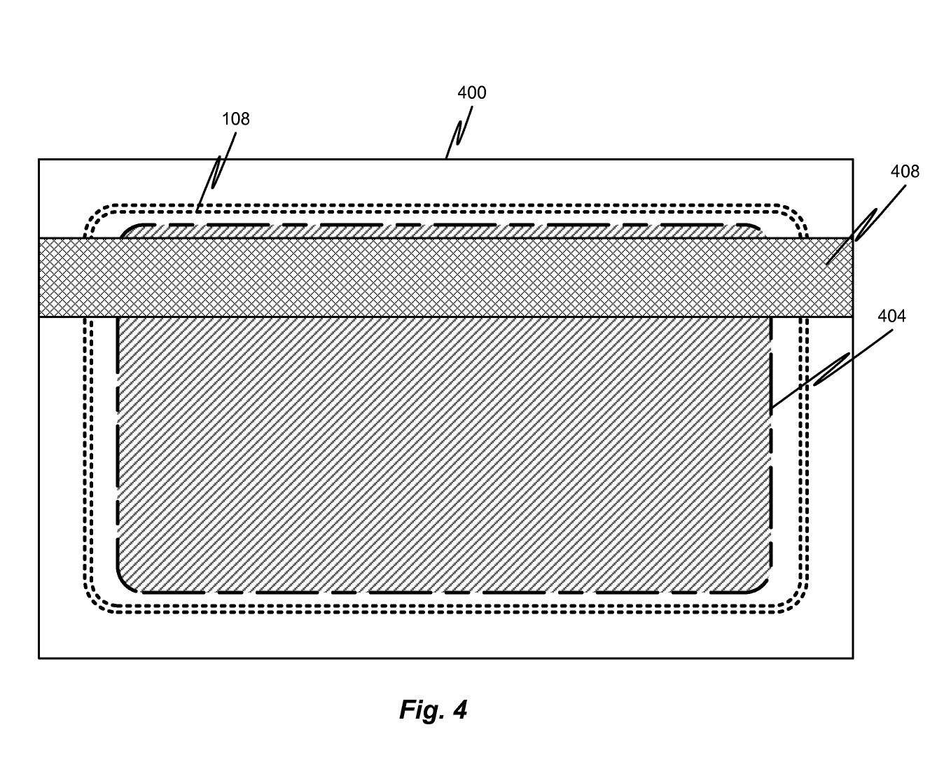

Referring now to FIG. 4, another example of a transponder 400 will be described in accordance with embodiments of the present disclosure. The transponder 400 shows another security feature that may be created on the transponder 400 with the transparent conductive material described herein. In particular, the nanoparticle ink may not only be used to create conductive components of a transponder, but the nanoparticle ink may also be printed on the transponder 400 to create a transparent optical memory media.

A depicted in FIG. 4, the transponder 400 may comprise both an antenna 108 (and other conductive components although not specifically described in connection with this example) and a transparent optical memory portion 404. The transparent optical memory portion 404 may be created with material that is similar or identical to the material used to create the antenna 108. Moreover, the transparent optical memory portion 404 and antenna 108 may be printed on the same surface of the transponder 400 (e.g., a common substrate surface) and they may even be printed in a common printing step.

After the transparent optical memory portion 404 is established on the transponder 400, it may be covered with a protective material, such as a clear layer of PET. Data may subsequently be written into the transparent optical memory portion 404 by using a data writing apparatus that is designed to alter the optical properties of the transparent optical memory portion 404. Even more specifically, the material used to create the transparent optical memory portion 404 may be transparent in the visible portion of the light spectrum, but capable of absorbing in the near-infrared portion of the light spectrum. The IR absorption properties of the material enable data to be written into the transparent optical memory portion 404 and subsequently read by a reader, interrogator, or the like.

Alternatively, or in addition, a magnetic stripe (i.e., magstripe) 408 may be established over the printed layers of transparent conductive material. This magstripe 408 may be placed directly over the antenna 108 and/or transparent optical memory portion 404. Alternatively, the magstripe 408 may be placed on one surface of the transponder 400 and the antenna 108 and transparent optical memory portion 404 may be printed on the opposite surface of the transponder 400. In some embodiments where the magstripe 408 is located on the same side of the transponder 400 as the antenna 108 and/or transparent optical memory portion 404, a clear plastic layer may be positioned between the magstripe 408 and the transparent conductive material that has been printed on the substrate of the transponder 400 to establish the antenna 108 and/or transparent optical memory portion 404. It may also be possible to print the antenna 108 and/or transparent optical memory portion 404 over the magstripe 408 or portions thereof.

It should be noted that the transponder 400 may be similar or identical to any other transponder described herein (e.g., transponder 100 or 300) and any features discussed in connection with one transponder (e.g., transponder 400) may be applied to any other transponder (e.g., the transponder 300 or transponder 100).

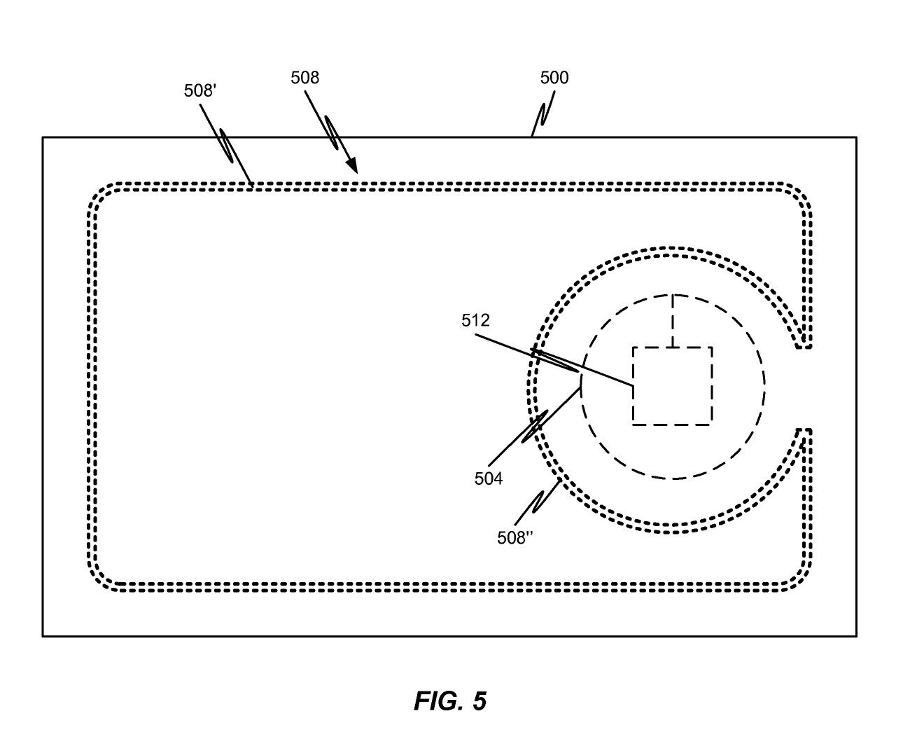

With reference now to FIG. 5, a transponder 500 having its RFID chip 512 inductively coupled to a booster antenna 508 will be described in accordance with embodiments of the present disclosure. In particular, the transponder 500 does not depend solely on conductive contact to carry current between the antenna 508 and the RFID chip 512. Rather, the RFID chip 512 is embedded with a first antenna 504 in the substrate material of the transponder 500. More specifically, the substrate of the transponder 500 may comprise multiple plastic layers that have the first inductive antenna 504 and RFID chip 512 laminated or otherwise fixed therebetween.

A booster antenna 508 is then created at the surface of the transponder 500 with the transparent ink. As represented schematically on the FIG. 5, the booster antenna 508 comprises essentially a primary antenna portion 508′ and a secondary antenna portion 508″ which are coupled in series. The primary antenna portion 508′ is configured for long range communication with an external RFID reader, and the secondary antenna portion 508″ is configured to be inductively coupled to the antenna 504 of the RFID chip 512. In other words, the primary antenna portion 508′ may be responsible for transmitting signals to and receiving signals from a reader/interrogator/writer while the secondary antenna portion 508″ is responsible for inductively carrying signals received at the primary antenna portion 508′ to the first antenna 504 as well as relaying signals received from the first antenna 504 to the primary antenna portion 508′ for transmission by the primary antenna portion 508′.

Additional details of suitable arrangements for the antennas 504, 508 and other components of the transponder 500 are described, for instance, in U.S. Pat. No. 5,270,717 or U.S. Patent Publication No. 2009/152362, the entire contents of which is hereby incorporated herein by reference in its entirety. It should be noted that the transponder 500 depicted in FIG. 5 is primarily schematic and the antennas 504, 508 may have more complex forms/arrangements without departing from the scope of the present disclosure.

Similar to FIG. 4, it should be noted that the transponder 500 may be similar or identical to any other transponder described herein (e.g., transponder 100, 300, or 400) and any features discussed in connection with one transponder (e.g., the transponder 500) may be applied to any other transponder (e.g., the transponder 400, 300, or 100).

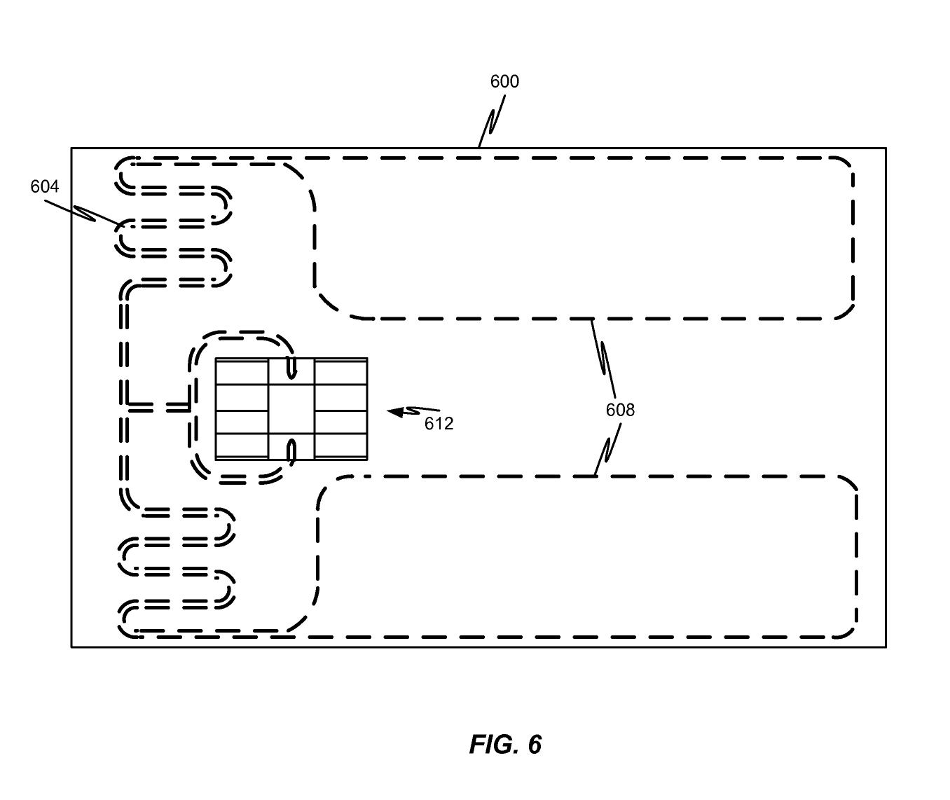

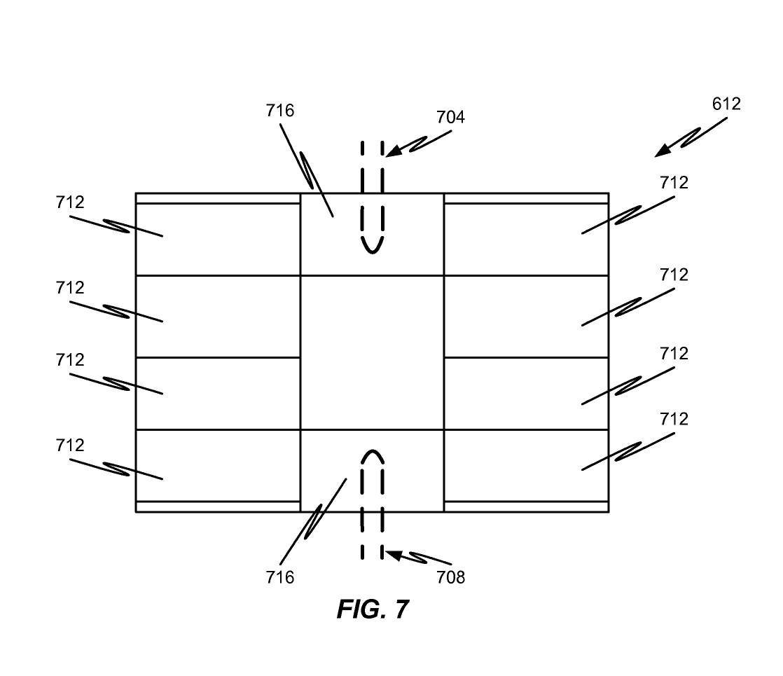

With reference now to FIGS. 6 and 7, yet another transponder 600 arrangement will be described where at least some conductive components thereof are constructed with the transparent conductive material. More particularly, the transponder 600 comprises a different antenna arrangement 604 having two large resonant surfaces 608 rather than a traditional loop-antenna as described in connection with the previous transponders. In some embodiments, the antenna 604 corresponds to an Ultra-High Frequency (UHF) dipole-type antenna. The antenna 604 may be similar to previously-described antennas in that some or all of the antenna 604 may be constructed with a transparent conductive material.

The transponder 600 also employs a dual-interface module 612 to store data and instructions for communicating such data to a reader/interrogator. As the name suggests, the dual-interface module 612 may be capable of communicating the data stored thereon to an external reader/interrogator via contact-based or contactless methods.

More specifically, and with reference to FIG. 7, the dual-interface module 612 may comprise standardized contact pads 712 (ISO/IEC 7810 and ISO/IEC 7816) for establishing the contact connection with contact pins of a reader head. In the present embodiment, the module 612 is specially designed in order to present on its upper surface, offside of the standardized contact pads 712, contactless pads 716 for connecting the dual-interface module 612 to the antenna 604 via terminal portions 704, 708 of the antenna 604.

Terminal portions 704, 708 of the antenna 604 as well as the resonant surfaces 608 may be printed on the same surface where the pads 716 of the dual-interface module 612 are exposed. In other words, the terminal portions 704, 708 of the antenna 604 may be printed on the pads 716 of the dual-interface module 612. This may correspond to the same surface of the substrate where the resonant surfaces 608 are printed.

Similar to the other conductive components described herein, the antenna 604 or portions thereof (e.g., resonant surfaces 608 and/or terminal portions 704 and 708) may be constructed of a transparent conductive material. Because the resonant surfaces 608 cover a significant portion of the surface of the substrate, the advantages of using a transparent conductive material for the antenna 604 are even more pronounced.

Although the embodiment of transponder 600 employing the dual-interface module 612 is depicted as having the UHF dipole-type antenna with the resonant surfaces 608, it should be appreciated that the dual-interface module 612 may employ any of the loop arrangements (e.g., antenna 108) described herein without departing from the scope of the present disclosure.

While illustrative embodiments of the disclosure have been described in detail herein, it is to be understood that the inventive concepts may be otherwise variously embodied and employed, and that the appended claims are intended to be construed to include such variations, except as limited by the prior art.

What is claimed is:

1. A transponder, comprising:
an RFID chip including commands stored therein to exchange communications with an RFID reader; and
an transparent antenna configured to enable the RFID chip to exchange one or more messages with the RFID reader, the antenna being at least partially constructed with a transparent conductive material that comprises a plurality of nanometer-sized conductive elements in a transparent polymer solution, the transparent conductive material being deposited to form at least one portion of the antenna.

2. The transponder of claim 1, wherein the refractive index of the polymer solution is unaffected by the nanometer-sized conductive elements such that the transparent conductive material is substantially transparent in the visible spectrum and has substantially no visible birefringence.

3. The transponder of claim 1, further comprising a plastic substrate on which the transparent antenna is printed.

4. The transponder of claim 3 being a card.

5. The transponder of claim 1, further comprising:
a transparent optical memory portion, the transparent optical memory portion also being at least partially constructed with the said transparent conductive material.

6. The transponder of claim 1, further comprising at least one visible graphic element that is printed on a plastic substrate.

7. The transponder of claim 6, wherein at least a portion of the transparent antenna is deposited over a portion of the at least one visible graphic element.

8. The transponder of claim 6, wherein the plastic substrate and the transparent antenna are covered by a protective transparent plastic layer.

9. The transponder of claim 1, wherein the transparent antenna is directly electrically connected to the RFID chip.

10. The transponder of claim 9, wherein the RFID chip is a dual-interface chip able to communicate in contact and contactless manner with external readers and is embedded in a dual interface module showing contact pads and contactless pads at the surface of the plastic substrate, wherein end portions of the transparent antenna are deposited on the contactless pads of the module.

11. The transponder of claim 1, wherein the transparent antenna is inductively coupled to the RFID chip.

12. The transponder of claim 1, wherein the transparent antenna comprises a plurality of loops.

13. The transponder of claim 1, wherein the transparent antenna is a UHF antenna.
